(19) United States
(12) Patent Application Publication
(10) Pub. No.: US 2021/0240951 A1
(43) Pub. Date: Aug. 5, 2021

(54) SCANNER, IN PARTICULAR A HAND-BACK SCANNER, WITH A MOUNTING BRACKET

(71) Applicant: ACD-Elektronik GmbH, Achstetten (DE)

(72) Inventors: Andreas Zwißler, Boos (DE); Alina Guther, Waldburg (DE)

(21) Appl. No.: 17/089,477

(22) Filed: Nov. 4, 2020

(30) Foreign Application Priority Data
Jan. 30, 2020 (DE) DE202020000429

(51) Int. Cl. G06K 7/10; H04B 1/034

(52) U.S. Cl. CPC G06K 7/10396; H04B 1/0343

(57) ABSTRACT

Scanner, in particular a back-of-hand scanner, with a holder, which essentially consists of a two-part housing with an integrated scanner and further assemblies for data transmission, with at least two commercially available, two-part or four-part push buttons being arranged on the housing of the scanner, which consist of a lower part and an upper part, which can be brought into operative engagement, the upper part of the respective push button on the underside of the housing of the scanner and the lower part of the respective push button are provided on a holder/fastening option for the scanner, characterized in that the push buttons (6) are made electrically conductive material and are designed as electrical interface contacts, on the one hand the upper parts (6) of the push buttons (6) of the scanner (1) have electrical connecting elements that connect to the additional electrical/electronic assemblies in the housing (2) of the scanner (1), while on the other hand lower parts (6) of the push buttons 6 of the holder (7) are equipped with electrical connecting elements (9) which lead to the additional electrical/electronic assemblies in or on the holder (7).

The invention relates to a scanner, in particular a backhand scanner, with a mounting bracket. These scanners consist of a two-part housing with an integrated scanner as well as other components for data transmission, e.g. Bluetooth/radio connection.

Scanners, especially backhand scanners, are commonly used to ensure that the operator of the scanner is free to use his hands to carry out the necessary work. In scanners of this type, at least two commercially available snap fasteners of two-part or four-part design are arranged on the housing of the scanner. They consist of a lower part and an upper part, the upper part of the respective snap fastener being provided on the bottom of the scanner housing and the lower part of the respective snap fastener being provided on a mounting bracket/attachment mechanism, e.g. the back of a glove, a hand strap, a wrist strap, finger strap or the like for the scanner. This allows the scanner to be attached to or removed from the mounting bracket at any time, quickly, easily and without tools.

Scanners of this type are designed for logistics applications and are used especially in warehouse logistics, for picking (e.g. of small parts). They are used wherever fast and ergonomic scanning is required and both hands must be free to carry out the necessary work.

The disadvantage of this solution is that the snap fasteners can only provide a function for attaching the scanner to the mounting bracket and ultimately for both of these to be fastened to the operator, especially in the area of the back of the hand, forearm or finger, and they are therefore not available for taking on further functions. If electrical interface contacts are required for the respective application, for example to attach a button to trigger the scanner or to charge the scanner battery, these additional interface contacts would make the scanner unwieldy.

The task of the invention is to propose a solution with which, in addition to the mechanical fastening function for the scanner on the mounting bracket, the range of functions can be extended by means of the snap fasteners in order to provide a handy scanner for additional electrically or electronically structured tasks.

This task is solved in the case of a generic scanner with the features indicated in the description of claim 1, the forms of which can be seen in claims 2 to 4.

The advantages of the invention are that it provides a scanner in which the snap fasteners used to attach the scanner to the mounting bracket are simultaneously available as electrical interface contacts, with the upper parts of the snap fasteners leading to electrical/electronic assemblies (scanner trigger or scanner battery) in the scanner housing by means of electrical connecting elements, while the lower parts of the snap fasteners on the mounting bracket, designed as gloves or the like, are equipped with electrical connecting elements which are connected, for example, to a button arranged in or on the glove.

The invention is explained in more detail below by means of a design example and associated drawings.

The drawings show:

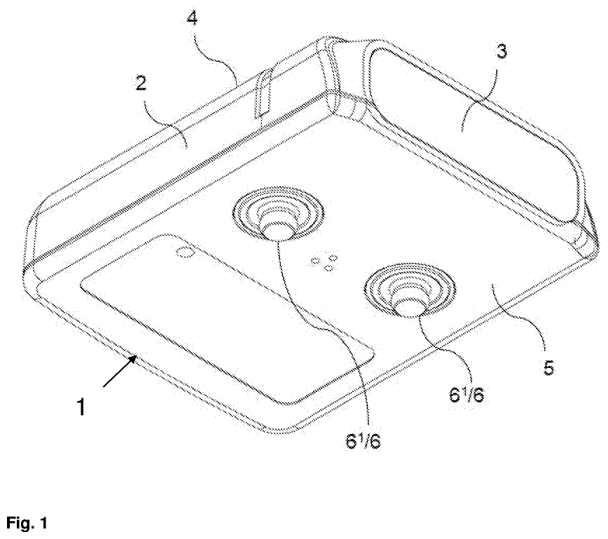

FIG. 1 A perspective bottom view of the scanner according to the invention

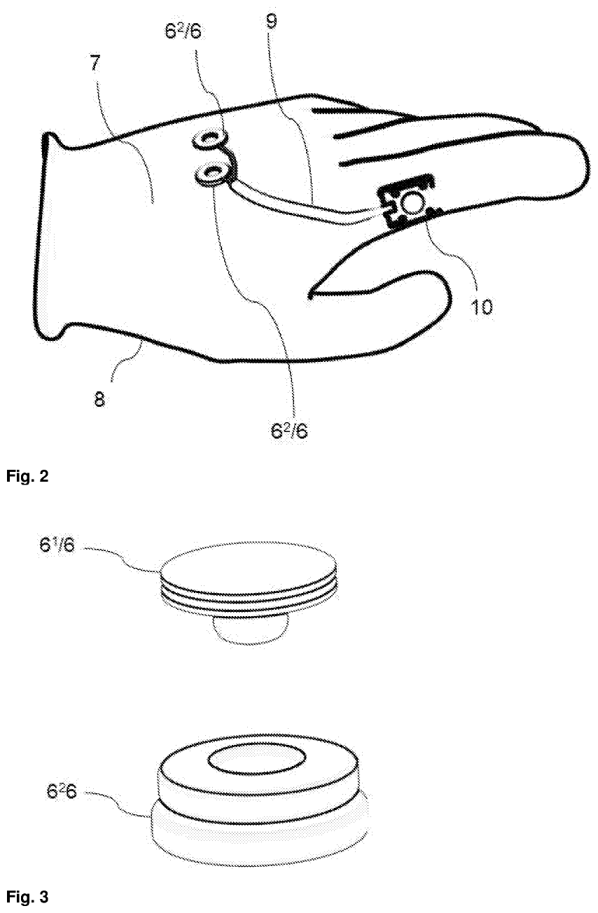

FIG. 2 A top view of the mounting bracket in the form of a glove for the scanner

FIG. 3 An exploded view of one of the snap fasteners

FIG. 1 shows a scanner 1 in the form of a backhand scanner. It consists of a preferably two-part housing 2 with an integrated scanner, further assemblies for data transmission, e.g. a Bluetooth/radio connection, and a scanner window 3, whereby on the top 4 of the housing 1, for example, an on/off button and viewing window for the status displays are provided. Two upper parts 6¹ of commercially available snap fasteners 6 are attached to the bottom 5 of housing 1.

A mounting bracket 7 designed as a glove for the scanner 1 is shown in FIG. 2. On the back 8 of this glove there are two lower parts 6² of the standard snap fasteners 6, which can be brought into active engagement with the two upper parts 6¹ of the snap fasteners 6 located on the bottom 5 of the housing 1 by pressing the upper parts 6¹ of the snap fasteners 6 into their lower parts 6² on the glove so the scanner 1 can be attached to and detached from the glove. In the illustration, the upper parts of the snap fasteners are connected to electrical/electronic assemblies for triggering the scanner by means of electrical connecting elements. In this version, the scanner trigger is located in the area of the back index finger and can be operated with the thumb. The electrical/electronic assembly may be placed inside the glove or on an outer surface of the glove.

The structure of one of these snap fasteners 6 is shown in FIG. 3.

The snap fasteners 6 are made of electrically conductive material, preferably brass with a surface of white bronze.

This creates the conditions for the snap fasteners 6 to be additionally used as electrical interface contacts.

For this purpose, the upper parts 6¹ of the snap fasteners 6 of the scanner 1 have electrical connecting elements that lead to the respective electrical/electronic assemblies (scanner trigger or scanner battery) in the housing 2 of the scanner 1 that are not shown.

The lower parts 6² of the snap fasteners 6 on the mounting bracket 7 designed as gloves or the like are equipped with electrical connecting elements 9 according to FIG. 2, which are connected for example with a button 10 located in or on the glove.

### LIST OF REFERENCE SIGNS USED

### 1 Scanner

### 2 Housing

3 Scanner window

### 4 Top of 2

### 5 Bottom of 2

6 Snap fasteners
6¹ Upper part of 6
6² Lower part of 6
7 Mounting bracket

### 8 Back of 7

9 Electrical connecting elements

### 10 Button

1. A scanner, in particular a backhand scanner, with a mounting bracket the scanner with the mounting bracket consisting essentially of a two-part housing with an integrated scanner and further assemblies for data transmission, wherein at least two two-part or four-part snap fasteners are arranged on the housing of the scanner, wherein the snap fasteners consist of a lower part and an upper part which can be brought into operative engagement, wherein the upper part of each snap fastener is provided on the bottom of the two-part housing of the scanner and the lower part of each snap fastener is provided on a mounting bracket/fastening mechanism for the scanner, characterized in that the snap fasteners consist of electrically conductive material and are constructed as electrical interface contacts, wherein on the one hand the upper parts of the snap fasteners of the scanner have electrical connecting elements which lead to the respective additional electrical/electronic assemblies in the housing of the scanner, while on the other hand the lower parts of the snap fasteners of the mounting bracket are equipped with electrical connecting elements which lead to the respective additional electrical/electronic assemblies in or on the mounting bracket.

2. The scanner of claim 1, wherein the electrically conductive material of the snap fasteners consists of brass with a surface of white bronze.

3. The scanner of claim 1, wherein the additional electrical/electronic assemblies in the housing of the scanner are designed as a scanner trigger or scanner battery.

4. The scanner of claim 1, wherein the additional electrical/electronic assembly is formed in or on the mounting bracket as buttons.
